(19) United States
(12) Patent Application Publication
(10) Pub. No.: US 2008/0201193 A1
(43) Pub. Date: Aug. 21, 2008

(54) Method of Commercializing Technology From Research Entities

(76) Inventor: Jan Buck, Princeton, NJ (US)

Correspondence Address: KAPLAN GILMAN GIBSON & DERNIER L.L.P., 900 ROUTE 9 NORTH, WOODBRIDGE, NJ, 07095, US

(21) Appl. No.: 12/032,151

(22) Filed: Feb. 15, 2008

Related U.S. Application Data
(60) Provisional application No. 60/890,104, filed on Feb. 15, 2007.
(60) Provisional application No. 60/894,509, filed on Mar. 13, 2007.

(51) Int. Cl. G06Q 30/00; G06Q 40/00; G06Q 10/00

(52) U.S. Cl. 705/8; 705/1; 705/35; 705/39

(57) ABSTRACT

Methods of business designed to commercialize technology from academic institutions, research laboratories or other early stage sources on a self-sustaining and positive cash generation basis. Methods herein provide an independent operating company the line of business of which is the process itself of commercialization of technologies for profit and cash generation endpoints in accordance with a business plan put in place for such purpose. An independent and perpetual operating company is operable to make an operating business of the commercialization projects and ventures it undertakes, making money for its own account under normal business plan from the full panoply of commercialization vehicles as needed to achieve the business plan rather than the happenstance needs of the target technologies, and generating a growth pattern in its financial metrics that will continue to enhance shareholder value in the company itself independent and apart from the projects and ventures it develops in its business.

### CROSS-REFERENCE TO RELATED APPLICATIONS

This application claims the benefit of U.S. Provisional Patent Application Nos. 60/890,104, filed Feb. 15, 2007 and 60/894,509, filed Mar. 13, 2007, the entireties of which are incorporated herein by reference.

### FIELD OF THE INVENTION

This invention relates to business methods for commercializing technology, and more specifically, business methods designed to commercialize technology from academic institutions, research laboratories or other early stage sources on a self-sustaining and positive cash generation basis.

### BACKGROUND OF THE INVENTION

Known models for general technology commercialization include venture capital firms, technology transfer offices, affiliated commercialization entities, incubators, management companies and public commercialization companies. Venture capital firms typically invest pools of funds raised from third parties into companies or businesses with defined business plans of third parties, have a limited life and typically liquidate in 10 years, distributing out its entire assets to the limited partners.

Technology transfer offices are administrative offices of universities and other research institutions and may employ as commercialization vehicles venture start-ups, licenses, contract research, and the like, but the operation of such offices is ad hoc to what is presented to them by researchers in their organizations; they do not operate under a business plan for profit and are mostly considered cost centers in their organizations. Technology transfer offices are administrative departments and not independent operating companies.

Affiliated commercialization entities have in the past been established by certain research organizations as outside entities to facilitate the commercialization objectives of the research organizations. Notable examples include Arch Capital organized by the University of Chicago and the Argonne Laboratories. However, while the principals of such commercialization entities might have shared in the returns of their work, the mission of such entities is to generate cash for their affiliated organizations and not operate solely for their own account; the technology is sourced from the organizer, i.e., the University or Argonne. These affiliated commercialization entities largely operated ad hoc, and the vehicles used were in mostly all cases startup venture companies.

The typical response to the need for commercialization by most research institutions is to start up captive venture funds. An example of an elaborate structure of this type was constructed by the Mayo Clinic and intended to be evergreen. These funds are strongly affiliated with their founding institutions and designed to generate whatever cash they can for the institution. In the 1990's The Hospital Association of Greater New York benchmarked existing commercialization models and organized AMDEC with a general objective of fostering commercialization at the constituent hospitals. However, this is more of an economic development organization than an operating entity and resembles other biotech EDA efforts that exist in virtually every major metropolitan region in the country and for that matter around the world.

The incubator model intends to do what the name suggests, incubate—in virtually all cases venture start-ups. They can be of the EDA type or research institution entities, but, particularly in the late 1990's, incubators did attract outside capital investment and became independent. A notable example of this was Bill Gross's “Idealab”. The model generally houses, nurtures and sometimes manages venture startups surrounding new technologies in the hope that some will be monetized through liquidity events. Incubators have historically not been designed as operating companies in their own right with operating metrics targeted to enhance shareholder value through the growth of the entity itself.

Management companies arise from time to time using seasoned executives who take on the role of the acting management team for new companies, typically for a large portion of equity and or a fee.

Public commercialization companies (PCCs) have recently appeared, mostly in the United Kingdom, that have gone public on the AIM in London. Most notable of these are Imperial Innovations Plc and IP Group Plc. Imperial Innovations was founded to commercialize technologies at Imperial College, London. IP Group PLC started by focusing on technologies at Kings College in London but now offers its services to a variety of UK universities. It, like Imperial Innovations, operates more like an extension of a university technology transfer office in attempting, for a fee, to find buyers or licensees for university inventions. While a PCC is intended to be a business, which a public listing would require, its technology base is limited; the PCC largely focuses on licensing, and it does not appear to have a plan for profitably conducting a going concern. It does not appear that either of the specified PCCs provides significant incubation help or development activity. Because of the initial success of these two entities other UK universities have tried to replicate them, but the market has soured on the model, in part because of the lack of significant financial returns.

No mechanism has yet been devised to make commercialization itself a sustainable and productive engine for monetizing academic research to support a profitable and growing going concern. Therefore there is a need for a business method that achieves this end.

### SUMMARY OF THE INVENTION

The business methods of the present invention are distinct from other known technology commercialization models fundamentally because in at least one embodiment methods of the present invention provide an independent operating entity the line of business of which is the process itself of commercialization of technologies for profit and cash generation endpoints in accordance with a business plan put in place for such purpose. This is in contrast to the traditional one-off model in which a single technology or related group of technologies is commercialized into a business in and of itself. In accordance with the present inventive methods, such a technology commercialized in the traditional one-off model would form only one component (such as a project and/or venture) of the business of the independent operating entity contemplated herein or of the entity itself.

In accordance with at least one embodiment a novel aspect of the present invention provides an independent and perpetual operating company to make an operating business out of the commercialization of the individual projects and ventures it undertakes, making money for its own account under a traditional business plan from the full panoply of commercialization vehicles as needed to achieve the business plan rather than the happenstance needs of the target technologies, and generating a growth pattern in its financial metrics that will continue to enhance shareholder value in the company itself independent and apart from the projects and ventures it develops in its business.

Methods are described herein that achieve the objective of making commercialization a sustainable and productive engine for monetizing academic research. To that end the presently described methods produce a cash-generating engine for the group of initial investors and founding individuals and institutions.

In accordance with one embodiment a method of doing business is provided which includes operationalizing a venture fund vehicle. In one aspect, the method preferably includes initially commercializing early stage academic science and generating fee income from industry customers to accumulate investment capital which can be used to invest in new projects and ventures to reach liquidity events generating more cash and capital for investment. Whereas a venture fund has a limited life and typically liquidates in 10 years distributing out its entire assets to the limited partners, the present inventive method is adapted to continue in perpetuity if desired. By way of comparison, if good biotech VC funds are supposed to deliver IRRs of 20-40% over their lives, the present inventive methods transform that level of performance into a very high CAGR for an operating company and enable continued growth.

In accordance with at least one embodiment the business methods described herein have the flexibility to employ the optimum commercialization vehicle such as but not limited to venture startup, licensing, contract research and the like, as appropriate, for 1) the particular technology and 2) the operating metrics and/or requirements at a given time. Those skilled in the art will recognize the appropriate vehicle(s) to employ under a given set of metrics and/or circumstances.

In accordance with one embodiment a method is provided of operationalizing a venture fund vehicle comprising commercializing early stage academic science, generating fee income from industry customers to accumulate investment capital, using the capital to invest in new projects and/or ventures to reach liquidity events, the liquidity events adapted to generate investment and working capital.

### DETAILED DESCRIPTION OF THE INVENTION

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” in various places in the specification are not necessarily all referring to the same embodiment.

A business method in accordance with at least one embodiment of the present invention includes a vehicle that is an operating company in the ordinary sense that optionally includes one or more features of a venture fund.

In accordance with at least one embodiment the business methods described herein have the flexibility to employ the optimum commercialization vehicle such as but not limited to venture startup, licensing, contract research and the like, as appropriate, for the particular technology and the operating metrics and/or requirements at a given time. Those skilled in the art will recognize the appropriate vehicle(s) to employ under a given set of metrics and/or circumstances.

In accordance with one or more embodiments, the present inventive methods may include providing a fund of capital to preseed fund projects and/or ventures (“P&V”) to develop technologies to the stage of institutional investment or industry collaborations or transactions and to generate early cash returns such as but not limited to licensing fees, fees from customer funded research and fees from providing services to industry.

In another embodiment the present invention may include providing a fund with funding commitments from large investors to be drawn down as capital investment requirements arise; cash generation from fee income; and/or licensing fees and liquidity events attributable to P&V financed with commitment drawdowns from investors flowing to operating returns to generate cash. The company may retain cash for further investment or to support operating expenses or make distributions to its investors. As the last of the commitments are drawn down upon, the company will have generated and accumulated sufficient cash to fund further P&V while at the same time distributing cash to investors as P&V achieve liquidity.

As used herein “liquidity” is defined as the availability to convert an asset to cash and can come at various stages of a P&V; for example, from inception such as in the case of contract research, where there is for example a fee for service, a license with up front fees, or the like; or the achievement of liquidity events such as initial public offerings, trade sales (e.g., in the case of venture companies) or the like.

In further embodiments, the company continues to generate cash to pay back to investors the full amount of investment capital, and, as more projects and ventures reach liquidity, investors continue to receive cash distributions and realize capital appreciation by virtue of the reinvestment of returns in new projects/ventures.

In a further embodiment, additional institutions that want to participate in the cash-generating engine pay increasing fees for inclusion as successes mount to the company. These fees are reflected in the company's operating income. The company grows as more institutions sign up such as but not limited to by membership or subscription fee to join in the robust commercialization scheme which is protected from copying by this patent.

In accordance with at least one embodiment a method may include the steps of establishing an entity, raising capital and capital commitments for equity investments in projects and/or ventures or the like, creating and supporting operating infrastructure, acquiring initial technologies from research labs/institutions to begin their development, drawing down from investors into the company capital required for initial equity investments by the company into development P&V (initial investors may have the right to invest directly side-by-side with the company if additional investment is desired or required), seed funding the initial P&V with draw downs, engaging industry customer(s)/partner(s), generating current cash income, such as but not limited to service for fees, sales of technology and the like from industry customer(s)/partner(s) to support operations and meet operating metrics, continuing to initiate development P&V, managing the seed fund and develop P&V drawing down on capital commitments as necessary therefor, beginning to achieve liquidity events for P&V, applying realized proceeds from liquidity events to operating income and operating cash, using accumulating operating cash for further investments in P&V while continuing to draw down on commitments until exhausted and distributions of cash to shareholders, using further realizations, investments and distribution to apply operating cash as necessary for operating expenses and G&A, generating self-sustaining cash for the growing base of P&V supporting the growing company and growing market valuation of the company, and charging admission fees from additional research laboratories or the like that are desirous of participating in the company's commercialization work, and treating the fees as operating income.

In one embodiment, by way of example only, ABC Company is the named sponsor of a new commercialization company. With a robust reservoir of technology in prolific research laboratories, such as but not limited to for example research hospitals, universities, incubators and/or the like, the company raises a large pool of capital from a small number of investors, such as but not limited to 5-7. This capital, for purposes of illustration, $120 million, would be allocated $20 million to cover G&A and operating expenses of the company for an initial period estimated to be long enough to become cash positive on an operating basis, and the balance to be drawn down from the investors as needed for investment in the commercialization ventures and projects.

The company finds promising technologies for commercialization in its reservoir that may be too immature for institutional financing or industry transactions. The company uses the skills of its professional team to develop and shape such technologies (produce market oriented data, for example), create the stories around them and house and populate the appropriate vehicle (licensing project, equity venture etc.) to carry the technology to a stage at which it can receive institutional finance or industry collaboration.

As an operating company, however, the company has operating metrics (P&L, cash flow etc.) rather than typical fund internal rate of return (IRR) calculus. As such in a preferred embodiment the initial focus, in addition to the seeding of a limited number of ventures, is cash generating activities such as licensing and fee based services for industry customers. In a preferred embodiment, a member of the investor pool would be a large industry participant who could invest in the equity of the company but also guarantee fee paying business as a customer of the company and possible exit opportunity for company technology investments. Such cash is used to refresh the operating expense fund. Early equity investments from investor draw-downs are preferably targeted to begin to reach liquidity in the initial period. Cash and returns from such liquidity events may go into the operating performance of the company and be treated as operating revenue rather than returns on investment as investment, development and liquidation will be the company's stock in trade.

As the cash accumulates and profits mount, the company may use the cash and profits to invest in further ventures and projects and have the discretion to distribute a portion of this cash from operations to its stockholders. Such distributions may be made independent of the availability of further investment commitment drawdowns and/or may be simultaneous with them. As the commitments are completely drawn down, the model contemplates the continued investments in projects and ventures using operationally generated cash. The model also contemplates the continued shareholder distributions until the investors' capital is completely paid back and beyond that on an on-going basis so that the company becomes a cash generation engine for its initial shareholders with a growing operational base internally. No investment beyond the initial round is required or contemplated though the initial investors may have the right before outside parties to invest directly side by side with the company in its individual projects and ventures. That is, after the initial period the model contemplates the company's continuing its growing commercialization business on a self-sustaining basis in perpetuity with the seed investing for projects and ventures being funded out of operating returns and cash and ongoing positive cash generation.

Growth is enhanced as new academic institutions join the company's reservoir of technology platforms, and for such participation which will support the company's growth, the company may charge a membership fee that will be reflected in operating revenues.

### EXAMPLES AND EXPERIMENTS

Table 1 shows an exemplary financial scenario in accordance with an embodiment of the present invention.

TABLE 1
Financial Projection - Summary

| | | Year 1 | | | | |
|---|---|---|---|---|---|---|
| | | 1^{st} Qtr | 2^{nd} Qtr | 3^{rd} Qtr | 4^{th} Qtr | Year 1 |
| Revenues | Fee-for-service | | | | | |
| | Pharma contract | 1,000,000 | 0 | 0 | 0 | 1,000,000 |
| | Licensing and technology sales | 0 | 0 | 0 | 0 | 0 |
| | Portfolio company exits | 0 | 0 | 0 | 0 | 0 |
| | Other revenues | 0 | 0 | 0 | 0 | 0 |
| | Total Revenues | 1,000,000 | 0 | 0 | 0 | 1,000,000 |
| Expenses | G&A | 811,375 | 898,375 | 898,375 | 898,375 | 3,506,500 |
| | Capital | 25,000 | — | — | — | 25,000 |
| | Total Expenses | 836,375 | 898,375 | 898,375 | 898,375 | 3,531,500 |
| Cash Flow from Operations | | 163,625 | (898,375) | (898,375) | (898,375) | (2,531,500) |
| Distribution to Shareholders | | | | | | 0 |
| Equity Investment | Drawdown from | | | | | |
| | Investment Commitment | 0 | 2,000,000 | 2,000,000 | 4,000,000 | 8,000,000 |
| | Cumulative Drawdown | 0 | 2,000,000 | 4,000,000 | 8,000,000 | 8,000,000 |
| | Total Cash (required)/surplus | 163,625 | (2,898,375) | (2,898,375) | (4,898,375) | (10,531,500) |
| | Cumulative cash (required)/surplus | | | | | (10,531,500) |
| | | Year 2 | | | | |
| | | 1^{st} Qtr | 2^{nd} Qtr | 3^{rd} Qtr | 4^{th} Qtr | Year 2 |
| Revenues | Fee-for-service | | | | | |
| | Pharma contract | 3,000,000 | 0 | 0 | 0 | 3,000,000 |
| | Licensing and technology sales | 0 | 1,000,000 | 0 | 1,000,000 | 2,000,000 |
| | Portfolio company exits | 0 | 0 | 0 | 0 | 0 |
| | Other revenues | 0 | 0 | 0 | 0 | 0 |
| | Total Revenues | 3,000,000 | 1,000,000 | 0 | 0 | 5,000,000 |
| Expenses | G&A | 1,169,325 | 1,182,525 | 1,182,525 | 1,182,525 | 4,716,900 |
| | Capital | 25,000 | — | — | — | 25,000 |
| | Total Expenses | 1,194,325 | 1,182,525 | 1,182,525 | 1,182,525 | 4,741,900 |
| Cash Flow from Operations | | 1,805,675 | (182,525) | (1,182,525) | (182,525) | 258,100 |
| Distribution to Shareholders | | | | | | 0 |
| Equity Investment | Drawdown from | | | | | |
| | Investment Commitment | 13,000,000 | 3,000,000 | 3,000,000 | 3,000,000 | 22,000,000 |
| | Cumulative Drawdown | 21,000,000 | 24,000,000 | 27,000,000 | 30,000,000 | 30,000,000 |
| | Total Cash (required)/surplus | (11,194,325) | (3,182,525) | (4,182,525) | (3,182,525) | (21,741,900) |
| | Cumulative cash (required)/surplus | | | | | (32,273,400) |
| | | Year 3 | | | | |
| | | 1^{st} Qtr | 2^{nd} Qtr | 3^{rd} Qtr | 4^{th} Qtr | Year 3 |
| Revenues | Fee-for-service | | | | | |
| | Pharma contract | 4,000,000 | 0 | 0 | 0 | 4,000,000 |
| | Licensing and technology sales | 1,000,000 | 1,000,000 | 2,000,000 | 2,000,000 | 6,000,000 |
| | Portfolio company exits | 0 | 0 | 0 | 0 | 0 |
| | Other revenues | 2,000,000 | 0 | 0 | 0 | 2,000,000 |
| | Total Revenues | 7,000,000 | 1,000,000 | 2,000,000 | 2,000,000 | 12,000,000 |
| Expenses | G&A | 1,427,690 | 1,427,690 | 1,427,690 | 1,427,690 | 5,710,760 |
| | Capital | 25,000 | — | — | — | 25,000 |
| | Total Expenses | 1,452,690 | 1,427,690 | 1,427,690 | 1,427,690 | 5,735,760 |
| Cash Flow from Operations | | 5,547,310 | (427,690) | 572,310 | 572,310 | 6,264,240 |
| Distribution to Shareholders | | | | | | 0 |
| Equity Investment | Drawdown from | | | | | |
| | Investment Commitment | 4,000,000 | 4,000,000 | 4,000,000 | 14,000,000 | 26,000,000 |
| | Cumulative Drawdown | 34,000,000 | 38,000,000 | 42,000,000 | 56,000,000 | 56,000,000 |
| | Total Cash (required)/surplus | 1,547,310 | (4,427,690) | (3,427,690) | (13,427,690) | (19,735,760) |
| | Cumulative cash (required)/surplus | | | | | (52,009,160) |
| | | Year 4 | | | | |
| | | 1^{st} Qtr | 2^{nd} Qtr | 3^{rd} Qtr | 4^{th} Qtr | Year 4 |
| Revenues | Fee-for-service | | | | | |
| | Pharma contract | 0 | 0 | 0 | 0 | 0 |
| | Licensing and technology sales | 2,000,000 | 2,000,000 | 3,000,000 | 3,000,000 | 10,000,000 |
| | Portfolio company exits | 0 | 0 | 0 | 20,000,000 | 20,000,000 |
| | Other revenues | 2,000,000 | 0 | 0 | 0 | 2,000,000 |
| | Total Revenues | 4,000,000 | 2,000,000 | 3,000,000 | 23,000,000 | 32,000,000 |
| Expenses | G&A | 1,634,822 | 1,634,822 | 1,634,822 | 1,634,822 | 6,539,286 |
| | Capital | 25,000 | — | — | — | 25,000 |
| | Total Expenses | 1,659,822 | 1,634,822 | 1,634,822 | 1,634,822 | 6,564,286 |
| Cash Flow from Operations | | 2,340,179 | 365,179 | 1,365,179 | 21,365,179 | 25,435,714 |
| Distribution to Shareholders | | | | | 10,000,000 | 10,000,000 |
| Equity Investment | Drawdown from | | | | | |
| | Investment Commitment | 5,000,000 | 5,000,000 | 5,000,000 | 5,000,000 | 20,000,000 |
| | Cumulative Drawdown | 61,000,000 | 66,000,000 | 71,000,000 | 76,000,000 | 76,000,000 |
| | Total Cash (required)/surplus | (2,659,822) | (4,634,822) | (3,634,822) | (6,365,179) | (4,564,286) |
| | Cumulative cash (required)/surplus | | | | | (56,573,446) |

Table 2 shows the financial scenario and results of a model experiment employing the teachings of the present invention.

TABLE 2

| | | Year 1 | Year 2 | Year 3 | Year 4 |
|---|---|---|---|---|---|
| Revenues | Fee-for-service | | | | |
| | Pharma contract | 1,000,000 | 3,000,000 | 4,000,000 | 0 |
| | Licensing and | 0 | 2,000,000 | 6,000,000 | 10,000,000 |
| | technology sales | | | | |
| | Portfolio company | 0 | 0 | 0 | 20,000,000 |
| | exits | | | | |
| | Other revenues | 0 | 0 | 2,000,000 | 2,000,000 |
| Total Revenues | | 1,000,000 | 5,000,000 | 12,000,000 | 32,000,000 |
| Expenses | Salaries | 1,584,000 | 1,674,000 | 1,968,480 | 2,161,728 |
| | Legal | 700,000 | 880,000 | 1,060,000 | 1,200,000 |
| | Institution Fee | 400,000 | 400,000 | 400,000 | 400,000 |
| | In-Licensing Tech. | 400,000 | 800,000 | 1,200,000 | 1,600,000 |
| | Accounting | 200,000 | 300,000 | 350,000 | 400,000 |
| | G&A | 765,500 | 740,500 | 760,500 | 780,500 |
| Total Expenses | | 4,049,500 | 4,794,500 | 5,738,980 | 6,542,228 |
| Cash Flow from Operations | | (3,049,500) | 205,500 | 6,261,020 | 25,457,772 |
| Distribution to Shareholders | | 0 | 0 | 0 | 10,000,000 |
| Equity Investments | Venture 1 | 2,500,000 | 4,000,000 | 5,000,000 | 0 |
| | Venture 2 | 3,000,000 | 5,700,000 | 3,200,000 | 0 |
| | Project 1 | 1,000,000 | 1,300,000 | 1,800,000 | 2,000,000 |
| | Project 2 | 1,500,000 | 11,000,000 | 16,000,000 | 18,000,000 |
| Total Investments | | 8,000,000 | 22,000,000 | 26,000,000 | 20,000,000 |
| Cumulative Drawdown | | 8,000,000 | 30,000,000 | 56,000,000 | 76,000,000 |
| | Total Cash | (11,049,500) | (21,794,500) | (19,738,980) | (4,542,228) |
| | (required)/surplus | | | | |
| | Cumulative cash | (11,049,500) | (32,844,000) | (52,582,980) | (57,125,208) |
| | (required)/surplus | | | | |

These examples and experiments are merely illustrative of possible additional applications of the presently described method and can be in no way construed as a limitation of the use thereof.

Applicants have attempted to disclose all embodiments and applications of the described subject matter that could be reasonably foreseen. However, there may be unforeseeable, insubstantial modifications that remain as equivalents. While the present invention has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

What is claimed is:

1. A method of operationalizing a venture fund vehicle comprising creating a governing operating business plan, commercializing early stage academic science, generating operating revenue from more than one commercialization vehicle, using generated revenue to invest in new projects and/or ventures to achieve liquidity thereby generating cash for further investment in projects and/or ventures.

2. The method according to claim 1 wherein a commercialization vehicle is selected from a venture company, contract service, license, and technology sale.

3. The method according to claim 1 wherein operating revenue is generated from a membership fee of participating entities.

4. The method according to claim 1 wherein the commercialization vehicles are employed based on the technology of a given project and/or venture and are employed to meet the objectives and metrics of the operating business plan.

5. A method of commercializing technology from at least one early stage source comprising the steps of establishing an entity, raising capital and optionally capital commitments for equity investments in one or more projects, acquiring at least one initial technology from an early stage source, beginning the development of the technology, drawing down from investors capital required for initial equity investments by the entity into the projects, seed funding the initial projects with draw downs, generating current cash income, and applying realized proceeds from liquidity events to operating income and operating cash.

6. The method according to claim 5 comprising using accumulating operating cash for further investments in projects.

7. The method according to claim 6 comprising continuing to draw down on commitments until exhausted.

8. The method according to claim 7 comprising making distributions of cash to shareholders while continuing business as a going concern, using at least one of further realizations, investments and distributions to apply operating cash to operating expenses.

9. The method according to claim 8 comprising generating cash for the entity.

10. The method according to claim 9 comprising charging fees from outside entities desirous of participating in the entity commercialization work and using the fees as operating income.

11. The method according to claim 5 wherein an early stage source is a university, research lab or private institution.

12. The method according to claim 5 comprising permitting one or more initial investors the right to invest directly with the company.

13. The method according to claim 5 comprising engaging one or more industry partner.

14. The method according to claim 5 wherein cash is generated through one or more sources including service fees, license fees and sales of technology.

15. The method according to claim 5 comprising managing the seed fund.

16. The method according to claim 5 comprising achieving liquidity events for projects.
